(19) United States
(12) Patent Application Publication
(10) Pub. No.: US 2012/0135185 A1
(43) Pub. Date: May 31, 2012

(54) PANEL ASSEMBLED FROM INDIVIDUAL TIMBERS FOR HIGH BUILDINGS

(76) Inventor: Hermann Preiss, Untergruppenbach (DE)

(21) Appl. No.: 13/388,744

(22) PCT Filed: Aug. 6, 2009
(86) PCT No.: PCT/EP2009/060192

§ 371 Date: Feb. 9, 2012

(51) Int. Cl. B32B 5/12; B27D 1/00

(52) U.S. Cl. 428/106; 144/344

(57) ABSTRACT

The invention relates to a panel assembled from individual timbers for high buildings, wherein a plurality of layers of parallel square timbers (1) are arranged lying on one another with predefined crossing angles between the square timbers of adjacent layers and are joined to one another at predefined crossing points by means of screws perpendicular to the planes of the layers.

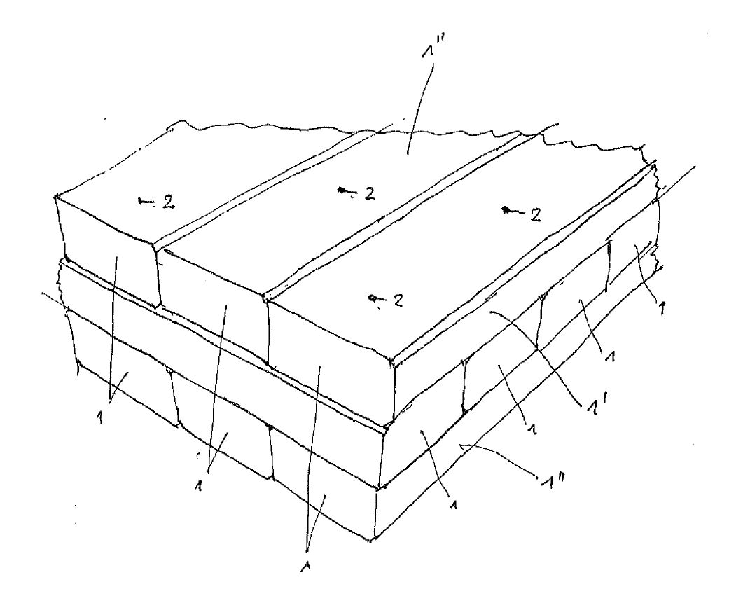

The invention relates to a panel for high buildings, which panel is assembled from individual pieces of timber or square pieces of timber that are pinned together.

Such panels are known in principle and can, for example, have square pieces of timber of rectangular cross sections arranged parallel to one another, wherein adjacent pieces of square timber abut on their narrow rectangular sides and are connected to one another by pins, in particular self-tapping screws, which pins are arranged parallel to the large rectangular sides. In this manner it is possible to produce panels that are practically of any desired size, which panels then in turn form the front and rear of wall modules whose modular core can comprise a bulk material, in particular chippings (PREMA system).

In principle, in the construction of high buildings highly stress-resistant panels are desired, which can be used as wall panels, floor panels or ceiling panels. In particular those panels are desired that even in the case of earthquakes can ensure good stability of the high buildings.

It is thus the object of the invention to create panels which provide particularly high stress-resistance and ductility or impact tolerance.

This objet is met by panels assembled from individual pieces of timber or square pieces of timber that are pinned together which according to the invention are characterised in that a plurality of layers of parallel individual pieces of timber or square pieces of timber are arranged lying on one another with predefined crossing angles between the square pieces of timber of adjacent layers and are joined to one another at predefined crossing points by means of screws perpendicular to the planes of the layers.

The invention is based on the general idea of creating a multilayer panel flexibly pinned from individual pieces of timber, in that each layer of individual pieces of timber is held together by the adjacent layer that is pinned together with it, with the individual pieces of timber of said adjacent layer crossing the individual pieces of timber of the other layer. In this manner a wood composite is created whose static load bearing capacity can reliably be calculated, which wood composite is distinguished by good earthquake resistance because impact forces acting on the panel result in more or less pronounced shear movements between adjacent individual pieces of timber or layers, and the friction occurring during this process results in effective impact absorption.

Apart from the above, with regard to preferred characteristics of the invention, reference is made to the claims and the following explanation of the drawing, by means of which a preferred embodiment of the invention is described in more detail.

Protection is claimed not only for stated or illustrated combinations of characteristics but also for in principle any desired combinations of the stated or illustrated individual characteristics.

In the drawing the sole FIGURE shows a perspective view of a panel according to the invention, which panel has flexibly connected individual pieces of timber.

The illustrated panel is of a three-layer design, wherein each layer has parallel square pieces of timber 1 that are lying against one another and that have a rectangular cross section, preferably with chamfered edges, wherein the large rectangular side is parallel to the plane of the respective layer. In the example shown, the square pieces of timber of each layer are aligned across the square pieces of timber of the adjacent layer, wherein the square pieces of timber of adjacent layers cross at right angles. However, in principle, other crossing angles are also possible.

At predefined crossing points the square pieces of timber 1 in each case of three layers are connected to one another by screws 2 which are preferably designed as self-tapping screws.

In the illustrated embodiment the screws 2 are provided at every second crossing of the square piece of timber 1′ with the square pieces of timber of the underlying (middle) layer. In the adjacent square piece of timber 1″ in each case the screws 2 are provided so as to be offset by a crossing. In contrast to the illustration, the screws 2 can also be provided on all crossings of the pieces of square timber 1′, 1″ etc. with the pieces of square timber of the adjacent middle layer. If need be the screws 2 can also have been put in place alternately from the square pieces of timber of the uppermost layer in the drawing, and from the square pieces of timber of the lowermost layer in the drawing.

In each case the screws 2 are of such a length that they can connect three layers of square pieces of timber to one another.

According to a particularly preferred embodiment, the pieces of square timber have a rectangular cross section of 4 cm×8 cm. In this case the self-tapping screws 2 have a length of 11 cm. If the screws 2 are all put in place from the same side of the panel, one panel face with a regular pattern of the screw heads and one panel face without visible screw components result. If a panel comprising more than three layers of square pieces of timber is to be produced, for example a four-layer panel, the next following layer of square pieces of timber is arranged on the previously manufactured three-layer panel with the use of further screws.

The panel shown can be used as a floor panel, ceiling panel and/or wall component or ceiling/roof component; said panel provides good resistance in case of a fire.

1-8. (canceled)

9. A panel for high buildings, which panel is assembled from long timber elements, comprising a plurality of layers of long timber elements arranged one beside another that are joined to one another by means of metal pins, wherein the elements of adjoining layers cross one another, wherein a plurality of layers of parallel square pieces of timber (1) lying against one another are arranged lying on one another and are joined to one another at predefined crossing points by means of self-tapping screws perpendicular to the planes of the layers, which screws in each case bind together square pieces of timber (1) of three layers.

10. The panel according to claim 9, wherein at least three layers are provided.

11. The panel according to claim 9, wherein the square pieces of timber (1) of adjacent layers cross one another at right angles.

12. The panel according to claim 9, wherein the square pieces of timber have a rectangular cross section whose long side is arranged parallel to the plane of the layers.

13. The panel according to claim 12, wherein the length ratio of the cross-section sides is 2:1.

14. The panel according claim 9, wherein the square pieces of timber have a cross section of 4 cm×8 cm.
